(19) United States
(12) Patent Application Publication
(10) Pub. No.: US 2026/0351933 A1
(43) Pub. Date: Nov. 5, 2026

(54) Cable Conduit

(71) Applicant: D-Line (Europe) Limited, North Shields Tyne and Wear (GB)

(72) Inventors: Paul Ruddick, North Shields Tyne and Wear (GB); Stephen Bianchi, North Shields Tyne and Wear (GB)

(21) Appl. No.: 19/110,573

(22) PCT Filed: May 16, 2023
(86) PCT No.: PCT/EP2023/063145

§ 371 Date: Mar. 11, 2025

(30) Foreign Application Priority Data
Sep. 12, 2022 (GB) 2213312.8

(51) Int. Cl. H02G 3/04

(52) U.S. Cl. CPC H02G 3/0418

(57) ABSTRACT

A conduit for housing cables is provided having a longitudinal axis and comprising a lid portion and a base portion having a planar base element. The lid portion is attached to the base portion by a longitudinally-extending hinge located on a first side of the longitudinal axis of the conduit. The lid portion is rotatable relative to the base portion about the hinge between an open configuration and a closed configuration. The hinge has an axis of rotation which is coplanar with the planar base element of the base portion. The lid portion comprises a fastening portion on a second side of the longitudinal axis, the fastening portion comprising an outer wall and an inner projection. The base portion comprises a retaining element configured to engage with the inner projection. In the open configuration: the lid portion is angularly displaced about the hinge, relative to the base portion, to define a gap between the lid portion and the base portion at the second side of the longitudinal axis of the conduit. In the closed configuration: the inner projection is engaged with the retaining element such that relative rotation between the lid portion and the base portion from the closed configuration to the open configuration is prevented, and inner surfaces of the base portion and the lid portion define a cable-retaining channel. In response to an inward transverse force being applied to the outer wall of the fastening portion, the inner projection is configured to disengage from the retaining element thereby allowing relative rotation of the lid portion from the closed configuration to the open configuration.

### TECHNICAL FIELD OF THE INVENTION

The present invention relates to a conduit for housing cables.

### BACKGROUND TO THE INVENTION

Conduits, or trunking, may be used to conceal and protect cables, pipework, and wires to prevent damage from sharp objects, impact or moisture. Some conduits are surface mounting conduits for mounting onto surfaces such as walls or skirtings. Surface mounting conduits can be useful for concealing cables while avoiding damage to the surface through the use of fixings such as screws or by drilling holes into the surface for concealing the cables. In addition, surface-mounted conduits are also useful where the cables, wires or pipes, are required to be changed since surface-mounted conduits allow for easy access.

EP 1 723 707 B1 describes surface-mounted conduits having a semi-circular cross section and a hinged lid to allow access to the channel inside the conduit and a clipping mechanism for clipping the lid to a base portion.

However, the clipping mechanism of EP 1 723 707 B1 is visible when the conduits are mounted to a surface which can tempt potentially hazardous efforts to unnecessarily open the conduit and tamper with the cables or wires inside. In addition, the groove created by the clipping mechanism forms a cavity that is an ingress point where dust and bacteria can accumulate compromising cleaning controls or causing hygiene programs. Moreover, the hinge on the opposite side of the conduits of EP 1 723 707 B1 is typically formed of a PVC extrusion, or similar non-metallic material, having a thinner section that deforms to be a flexible hinge. A drawback to such a thinned section is that the hinge can be prone to ripping and tearing. Moreover, the hinge can gain unsightly stress marks appearing when the lid is opened or closed several times. The appearance of stress marks in single material conduits can be especially conspicuous on non-white, coloured conduits.

An alternative way of forming a hinge is by using an alternative material that is inherently durable and flexible, such as elastomer or a plasticised rubber, to make a hinge that also serves to bond the base and lid as a composite piece. A drawback to having a visible hinge being made by using an alternative material is that this visible hinge will have different properties to the main body base and lid material. The different materials may then accumulate dust at different rates which can cause an undesirable colour mismatch between the hinge and the main body. It is also notable that having any such hinge mechanism means that if the conduit is painted the visible location of the hinge on the side of the conduit can cause cracking or peeling of the paint on the hinge section when the conduit is opened or closed. Therefore, it is an aim of the present inventors to provide a conduit for installation in areas where appearance matters, which has a smooth profile with no externally conspicuous features. Such a conduit may be more easily accepted as a decorative trim or feature than traditional conduits with obviously functional external features.

The present invention has been devised in light of the above considerations.

### SUMMARY OF THE INVENTION

Broadly speaking the present invention aims to address this problem with the provision of a conduit for housing cables which may include a mechanism which enables the conduit to be opened simply by squeezing the sides together. Furthermore, in order to provide a sleeker appearance, a hinge mechanism of the conduit may be located on a back (i.e. wall-engaging or floor-engaging) surface.

Accordingly, a first aspect of the present invention provides a conduit for housing cables, the conduit having a longitudinal axis and comprising a lid portion and a base portion, the base portion having a planar base element, wherein:
the lid portion is attached to the base portion by a longitudinally-extending hinge located on a first side of the longitudinal axis of the conduit, the lid portion being rotatable relative to the base portion about the hinge between an open configuration and a closed configuration, and the hinge having an axis of rotation which is coplanar with the planar base element of the base portion;
the lid portion comprises a fastening portion on a second side of the longitudinal axis, the fastening portion comprising an outer wall and an inner projection, and the base portion comprises a retaining element configured to engage with the inner projection;
in the open configuration: the lid portion is angularly displaced about the axis of rotation of the hinge, relative to the base portion, to define a gap between the lid portion and the base portion at the second side of the longitudinal axis of the conduit,
in the closed configuration: the inner projection is engaged with the retaining element such that relative rotation between the lid portion and the base portion from the closed configuration to the open configuration is prevented, and an inner surface of the base portion and an inner surface of the lid portion define a cable-retaining channel; and
in response to an inward transverse force being applied to the outer wall of the fastening portion, the inner projection is configured to disengage from the retaining element thereby allowing relative rotation of the lid portion from the closed configuration to the open configuration.

Conduits according to the first aspect of the invention are therefore simple and quick to open and close thereby enabling convenient access to the cable-retaining channel inside. Accordingly, installation, inspection and removal of cables in the conduit is quicker and more efficient than for traditional conduits.

Moreover, by virtue of the hinge having an axis of rotation which is coplanar with the planar base element, it is possible for the hinge to be mounted flush to a mounting surface thus hiding the hinge from view when the conduit is mounted to a mounting surface. In this way, cracking and peeling of paint may be reduced if the outer surface of the conduit is painted because the paint will not be deformed at the hinge when the conduit is opened and closed.

In addition, conduits according to the first aspect also avoid the disadvantages of having visible hinges and clipping mechanisms, as described in ‘Background’ and including but not limited to: making cavity access too easy when the conduit is mounted to a surface, providing an ingress for dust and bacteria, accumulating undesirable hinge stress marks or discolorations that give colour mismatches, and having overly functional non-decorative aesthetics.

The invention includes the combination of the aspects and preferred features described herein except where such a combination is clearly impermissible or expressly avoided.

The conduit, which may also be referred to as trunking or ducting, is configured for installation on flat surfaces such as floors, walls, desktops or skirtings. The conduit would also be suitable for objects other than cables such as pipework and wires.

The conduit may be an elongate member extending from a first opening at one end to a second opening at an opposite end. The longitudinal axis may dissect the conduit from the first opening to the second opening. In other words the longitudinal axis may be parallel to the direction from the first opening to the second opening (or vice versa). The lid portion or lid may extend from a first side of the longitudinal axis to a second side of the longitudinal axis. The base portion, or base, may also extend from the first side to the second side.

The first side of the longitudinal axis may be opposite to the second side of the longitudinal axis. Therefore, the hinge may be located on a first side of the conduit corresponding to a first side of the longitudinal axis. A locking mechanism comprising the retaining element of the base and the fastening portion of the lid may be located on a second side of the conduit corresponding to the second side of the longitudinal axis.

When the lid is in the open configuration the inner projection of the fastening portion may be disengaged with the retaining element and there may be a gap or opening between the lid and the base. Specifically, when the lid is in the open configuration, the gap may be defined between a lower edge of the lid portion and an upper edge of the retaining element. A user may install a cable or wires into the conduit through the gap.

When the lid is in the open configuration, with the planar element of the base resting on a horizontal surface, the lid may rest against a top surface of the retaining element but without engaging with the retaining element in a retaining position. Therefore, a user may lift the lid so that there is relative rotation between the lid portion and the base portion, thus enlarging a gap between the base and lid for installing cables.

When the lid is in the closed configuration, such that relative rotation between the lid portion and the base portion from the closed configuration to the open configuration is prevented, the lid may be locked or clipped to the base portion.

In the context of the present invention, the term “transverse” is used to refer to a direction which is perpendicular to the longitudinal axis. “Inward” is used to refer to a direction which is towards (rather than away from) the longitudinal axis. The inward transverse force may be considered as a force being applied to an exterior of the conduit towards the interior of the conduit where transverse is in relation to the longitudinal axis. The inward transverse force may be applied in a direction from the second side of the longitudinal axis towards the first side of the longitudinal axis.

The inward transverse force being applied to the outer wall of the fastening portion may be referred to as a deformation or actuation force. The inward transverse force may be applied by a user pushing on or squeezing the outer wall of the fastening portion. The outer wall of the fastening portion may be configured to resiliently deform towards the interior of the conduit when the inward transverse force is applied. Preferably, the term “inward transverse force” should be understood to refer to a force which is applied at an outer edge of the lid (i.e. at the outer wall), and is directed laterally inwards. In this way, the resulting deformation is optimized to disengage the inner projection from the retaining element, enabling the conduit to open.

The inner projection may be configured to disengage from the retaining element by moving apart from the retaining element as a result of the inward transverse force being applied to the outer wall of the fastening portion. The disengagement of the inner projection from the retaining element may be considered as the lid unlocking or unclipping from the base.

The lid portion may be biased towards the open configuration, in which the inner projection is disengaged with the retaining element. In this way, when the inner projection disengages from the retaining element, as a result of the inward transverse force, the bias causes the lid portion to rotate, about the axis of rotation, relative to the base portion from the closed configuration towards the open configuration. A user may then manually lift the lid portion away from the retaining element, further rotating the lid portion about the axis of rotation, creating a larger space between the lid portion and the base portion allowing full access to the cavity.

Accordingly, the conduit is easy and convenient to open, enabling convenient installation and removal of cables.

In the context of the present application, the term “planar base element” should be understood to mean a planar or substantially planar base element. The planar base element of the base portion may comprise a flat surface forming at least part of an outer mounting surface of the base element. The conduit may be mounted to a wall by attaching the mounting surface of the base element to the wall. The conduit may further comprise an adhesive pad located on an outer mounting surface of the planar base element of the base portion for attaching the conduit to a surface. In this way the conduit may be easily mount to a surface such as a wall without the need for visible fixings or to drill into the wall.

The planar base element of the base portion may be rectangular, the long edges of the rectangle being parallel to the longitudinal axis.

The inner surface of the base portion may be an inner surface of the planar base element which may be flat or planar. In some examples, the inner surface of the planar base element may not be flat but comprise protrusions or curves.

The hinge may be a living hinge formed of the same material as the lid portion and the base portion. In the context of the present application, a “living hinge” is used to refer to a thin flexible hinge or flexure bearing made from the same material as the two rigid pieces it connects. It is typically thinned or cut to allow the rigid pieces to bend along the line of the hinge. In other examples, the hinge may be formed of a separate piece of flexible material. In further examples, the hinge may be formed of rigid parts configured to rotate relative to each other.

The hinge may be located adjacent to the planar base element of the base portion. An outer mounting surface of the conduit including an outer surface of the planar base element of the base portion may also include the hinge. The outer mounting surface of the conduit may also include a part of the lid portion adjacent to the hinge which is coplanar with the planar base element of the base portion. Accordingly, when the conduit is mounted to a mounted surface the hinge may be hidden from view. Moreover, if the conduit is painted visible cracking and peeling of the paint may be reduced because the outwardly facing surfaces of the mounted conduit need not be deformed and folded by the action of the hinge.

The hinge may be located between an outer edge of the conduit and the longitudinal axis. By offsetting the hinge from the outer edge of the conduit the outer edge may perform a pivoting function when the conduit is opened at the hinge thereby rotating the lid portion relative to the base portion from the closed condition to the open condition. Therefore, if the conduit is mounted to a surface the outer edge may push against the mounting surface when the lid is in the open configuration thereby biasing the lid towards the base and performing an additional cable retaining function.

The hinge may be configured to have a flat or substantially flat outer surface when the lid portion is in the closed configuration. The flat outer surface of the hinge may be flush or substantially flush with the planar base element of the base portion when the lid portion is in the closed configuration. In other examples, the hinge may be recessed into the conduit relative to the outer surface of the planar base element. Accordingly, the conduit may be mounted flush to a wall without having to accommodate a protruding hinge.

The retaining element of the base portion may be integrally formed with the planar base element. In this way, the base potion may be manufactured, for example by moulding or extrusion, as a single part.

The inner projection may be resiliently biased towards the outer wall such that when the lid is in the closed configuration the retaining element is resiliently biased towards a retaining position wherein the inner projection is engaged with the retaining element. Accordingly, a more secure and reliable connection may be made between the lid and base thereby preventing the lid from opening when it is not desired.

The inner projection may be resiliently deformable such that in response to a closing force acting to cause rotation of the lid portion relative to the base portion from the open configuration to the closed configuration the inner projection is pushed against the retaining element and is configured to deform to move into a retaining position whereby the inner projection engages with the retaining element. Therefore, the conduit is simple and convenient to close in a single action by a user. More specifically, during a closing operation as described, the inner projection may deform, relative to the retaining element, and when the relative angular displacement between the base portion and lid portion decreases to a threshold relative angular displacement, the inner projection may snap (i.e. spring back) into a non-deformed or less-deformed state, in the retaining position.

In other examples, the retaining element may be resiliently deformable such that in response to a closing force acting to cause rotation of the lid portion relative to the base portion from the open configuration to the closed configuration the inner projection is pushed against the retaining element causing the retaining element to deform thus allowing movement of the inner projection into a retaining position whereby the inner projection engages with the retaining element. Therefore, the conduit is simple and convenient to close in a single action by a user. More specifically, during a closing operation as described, the retaining element may deform, relative to the inner projection, and when the relative angular displacement between the base portion and lid portion decreases to a threshold relative angular displacement, the retaining element may snap (i.e. spring back) into a non-deformed or less-deformed state, in the retaining position.

The retaining element may comprise a ledge having a lower abutment surface. The lower abutment surface may be parallel or substantially parallel to the planar base element of the base portion. The inner projection may comprise a hook configured to fit under the ledge and to engage with the lower abutment surface when the lid portion is in the closed configuration. The hook may be an elongate hook comprising a supporting arm and an upturned portion wherein the supporting arm protrudes from an upper portion of the lid at an upper end of the supporting arm and the upturned portion protrudes from a lower end of the supporting arm in a direction partially towards the upper portion of the lid. The engagement between the lower abutment surface and the hook may prevent relative rotation of the lid portion relative to the base portion from the closed configuration to the open configuration. Accordingly, the lid may be locked securely to the base portion using the hook and ledge arrangement.

The hook may include an upper abutment surface configured to engage with the lower abutment surface of the ledge when the lid portion is in the closed configuration, the engagement between the lower abutment surface and the upper abutment surface preventing relative rotation of the lid portion relative to the base portion from the closed configuration to the open configuration. The upper abutment portion may be parallel or substantially parallel to an upper portion of the lid portion.

The inner projection may comprise a hook and be resiliently deformable. The restraining element may comprise a ledge and be resiliently deformable.

At least one of the inner projection and the retaining element may comprise a guiding element configured to guide the hook under the ledge in response to a closing force acting to cause rotation of the lid portion relative to the base portion from the open configuration to the closed configuration. Therefore, more reliable engagement of the inner projection with the restraining element may be achieved upon a closing action being performed by a user. In this way, there is a lower likelihood that the user will be required to make multiple attempts to lock the lid to the base. In addition, the inner projection may be guided into a correct position more reliably, reducing potential wear or deformation to the fastening mechanism of the conduit after multiple uses.

The retaining element may comprise a guiding element in the form of a ramp adjacent to the ledge, an upper ramp surface of the ramp at an angle of 30° to 80° relative to the planar base element, and wherein in response to a closing force applied to the lid portion acting to cause rotation of the lid portion relative to the base portion from the open configuration to the closed configuration, at least a portion of the inner projection is configured to slide along the upper ramp surface, thereby guiding the inner projection into a retaining position. The upper ramp surface may be more preferably at an angle 40° to 70°, or more preferably 50° to 60°, relative to the planar base element. In this way, the inner projection may be reliably guided into the retaining position thereby reducing the likelihood of damage to the conduit when the lid is being closed.

The upper ramp surface of the ramp may be at an angle of 20° to 80° relative to the lower abutment surface, or more preferably 30° to 70°, more preferably 40° to 60°.

When the inner projection is biased towards the retaining position and the retaining element comprises an upper ramp surface, the lid portion may be automatically moved from the closed configuration towards the open configuration when the transverse inwards force is applied to the outer wall. In other words, when the transverse inwards force is applied to the outer wall causing the hook of inner projection to disengage from the lower abutment surface of the ledge, the biasing force of the inner projection may cause the hook to slide along the upper ramp surface thus pushing the lid portion towards the open position. Accordingly, the conduit is simple and easy to open.

The hook of the inner projection may comprise a guiding element which is a lower ramp surface. The lower ramp surface may have an angle of 20° to 80° relative to the planar base element. In response to a closing force applied to the lid portion acting to cause rotation of the lid portion relative to the base portion from the open configuration to the closed configuration, at least a portion of the retaining element may be configured to slide along the lower ramp surface, thereby guiding the inner projection into a retaining position. The lower ramp surface may be more preferably at an angle 30° to 70°, or more preferably 40° to 60°, relative to the planar base element when the lid is in the closed position. In this way, the inner projection may be reliably guided into the retaining position thereby reducing the likelihood of damage to the conduit when the lid is being closed.

The lower ramp surface of the hook may be the upturned portion of the hook protruding from a shaft or supporting member wherein the upturned portion may extend from the shaft at an angle of 20° to 80°, 30° to 70°, or more preferably 40° to 60°, relative to the shaft.

The lid portion of the conduit may comprise a planar lid element. Which is configured to be parallel with the planar base element of the base portion when the lid is in the closed configuration. In this example, the lower ramp surface may be configured to have an angle of 20° to 80°, more preferably 30° to 70°, or more preferably 40°to 60°, relative to the planar lid element.

Advantageously, when the inner projection is biased towards the retaining position and the inner projection comprises a lower ramp surface, the lid portion may be automatically moved from the closed configuration towards the open configuration when the transverse inwards force is applied to the outer wall. When a transverse inwards force is applied to the outer wall causing the hook of inner projection to disengage from the lower abutment surface of the ledge, the biasing force of the inner projection may cause the retaining element to slide along the lower ramp surface of the hook thus pushing the lid portion towards the open position. Accordingly, the conduit is simple and easy to open.

The retaining element and the hook of the inner projection may both comprise guiding elements, wherein the retaining element comprises a ramp having an upper ramp surface and the inner projection comprises a lower ramp surface. In response to a closing force applied to the lid portion acting to cause rotation of the lid portion relative to the base portion from the open configuration to the closed configuration, the lower ramp surface may be configured to slide along the upper ramp surface of the retaining element, thereby guiding the inner projection into a retaining position. Therefore, the inner projection may be more reliably guided into the retaining position reducing the likelihood of damage to the conduit when the lid is being closed and increasing reliability of the locking mechanism.

The angle of the upper ramp surface of the retaining element relative to the planar base element of the base portion and the angle of the lower ramp surface of the hook relative to the planar base element of the base portion may be complementary. In some examples, the angles may be within 5° of each other. In other examples, the angles may be the same. In this way, more reliable engagement of the inner projection with the retaining element may be achieved.

In the closed configuration, a lower edge of the outer wall of the fastening portion may be coplanar with the planar base element of the base portion. In this way the locking mechanism of the conduit, comprising the inner projection and the retaining element may be concealed by the outer wall of the lid. Therefore, the locking mechanism may be protected from dust, bacteria ingress and damage. The conduit may also be painted without paint penetrated the locking mechanism and sealing the conduit shut.

The conduit may further comprise multiple compartments for receiving different cables. The compartments may be separated by one or more interior walls extending from the planar base element of the base portion. The interior walls may be configured to touch an inner surface of the lid when the lid is in the closed configuration. In other examples the interior walls may have a length which is shorter than the distance between inner surfaces of the lid and the planar base element when the lid is in the closed configuration. In some examples, the conduit may comprise multiple interior walls having different heights. In this way, cables and wires being housed in the conduit may be prevented from tangling.

The interior walls may be removable from the conduit. Accordingly, the conduit may be adjusted to suit user preferences and to accommodate different numbers and sizes of cables, pipes, and wires.

The conduit may have a rectangular outer cross-section. The rectangular outer cross-section may comprise rounded corners.

The lid portion may comprise a planar lid element which is parallel to the planar base element of the base portion when the lid portion is in the closed configuration. The outer wall of the fastening portion may be curved. The conduit may comprise a curved side joining a portion of the lid coplanar with the planar base element to the planar lid element. Accordingly, the conduit may have a low profile allowing it to be discreetly mounted to a wall or to fit into narrow spaces.

The conduit may have a semi-circular outer cross-section or domed cross-sections. Therefore, the conduit may be mounted flush to a wall along the planar base portion of the semi-circle. In implementations in which the conduit has a semi-circular cross section, and reference is made to another component being “parallel to an upper portion” or “parallel to an upper surface” of the lid portion, this should be understood to refer to a part of the upper portion of the lid portion which is parallel to the planar base element, when the conduit is in the closed configuration.

In other examples, the conduit may have a quarter circle cross-section. A quarter circular cross section may by useful for mounting the conduits in corners. In implementations in which the conduit has a quarter-circular cross section, and reference is made to another component being “parallel to an upper portion” or “parallel to an upper surface” of the lid portion, this should be understood to refer to a part of the upper portion of the lid portion which is parallel to the planar base element, when the conduit is in the closed configuration.

The conduit may be elongate and straight such that the conduit has a uniform cross-section from a first end of the conduit to a second end of the conduit along the longitudinal axis. The conduit may be straight and rigid. However, in some examples the conduit may be configured to have some flexibility to bend along its length.

The conduit may be configured to be joined by accessories to extend the length of the conduit or to accommodate corners.

The lid portion and the base portion of the conduit may be made of a thermoplastic. The thermoplastic may be rigid. For example, the lid portion and the base portion may be made from PVC.

The hinge may be made of a flexible thermoplastic. For example, the hinge may be made from TPE. The hinge may be configured to have a predetermined tension so that the lid portion can be held back when the conduit is open to facilitate the fixing of cables or pipes and then return to a position when the lid is released wherein the fastening portion of the lid rests against the retaining element of base portion.

The lid portion may by covered by a protective film or coating. The protective film may be made from PVC. This film may enable different finishes to be applied to the conduit, e.g. wood effect, metal effect, paint.

The lid portion may have a wall thickness of 0.7-2 mm, or more preferably 1 .mm +/−0.4 mm.

The conduit may have a length from a first end to a second end along the longitudinal axis of 30 mm-1200 mm and a width of 7 mm-30 mm respectively. A height of the conduit between a lower surface of the planar base element and an upper surface of a planar lid element when the lid is in the closed configuration may be between 10 mm-20 mm. However, other dimensions of conduit may be available to accommodate different sizes of cables, wires and piping.

A second aspect of the invention may provide a conduit for housing cables, the conduit having a longitudinal axis and comprising a lid portion and a base portion having a planar base element, wherein: the lid portion is attached to the base portion by a longitudinally-extending hinge located on a first side of the longitudinal axis of the conduit, the lid portion being rotatable relative to the base portion about the hinge between an open configuration and a closed configuration; the lid portion comprises a fastening portion on a second side of the longitudinal axis, the fastening portion comprising an outer wall and an inner projection, and the base portion comprises a retaining element configured to engage with the inner projection; in the open configuration: the lid portion is angularly displaced about the hinge, relative to the base portion, to define a gap between the lid portion and the base portion at the second side of the longitudinal axis of the conduit, in the closed configuration: the inner projection is engaged with the retaining element such that relative rotation between the lid portion and the base portion from the closed configuration to the open configuration is prevented, and inner surfaces of the base portion and the lid portion define a cable-retaining channel; and in response to an inward transverse force being applied to the outer wall of the fastening portion, the inner projection is configured to disengage from the retaining element thereby allowing relative rotation of the lid portion from the closed configuration to the open configuration. For completeness, we note that any features set out earlier in the application in respect of the first aspect of the invention may be combined with conduits of the second aspect of the invention.

A third aspect of the invention may provide a conduit for housing cables, the conduit having a longitudinal axis and comprising a lid portion and a base portion having a planar base element, wherein: the lid portion is attached to the base portion by a longitudinally-extending hinge located on a first side of the longitudinal axis of the conduit, the lid portion being rotatable relative to the base portion about the hinge between an open configuration and a closed configuration, and the hinge having an axis of rotation which is coplanar with the planar base element of the base portion; in the open configuration: the lid portion is angularly displaced about the hinge, relative to the base portion, to define a gap between the lid portion and the base portion at the second side of the longitudinal axis of the conduit; the conduit further comprises a releasable locking mechanism configured to prevent relative rotation between the lid portion and the base portion, thereby retaining the lid portion in the closed configuration; and in the closed configuration: inner surfaces of the base portion and the lid portion define a cable-retaining channel. For completeness, we note that any features set out earlier in the application in respect of the first aspect of the invention or the second aspect of the invention may be combined with conduits of the second aspect of the invention.

### BRIEF DESCRIPTION OF THE DRAWINGS

Embodiments of the present invention will now be described with reference to the accompanying drawings, in which:

FIG. 1 shows an end elevation of a closed conduit according to the present invention.

FIG. 2 shows an end elevation of an open conduit according to the present invention.

FIG. 3 shows a perspective view of an open conduit according to the present invention.

FIG. 4 shows a perspective view of a closed conduit according to the present invention.

FIGS. 5a and 5b show end elevations of a locking mechanism of a closed conduit according to the present invention.

FIGS. 6a and 6b show an end elevation and a perspective view of another conduit according to the present invention.

FIGS. 7a and 7b show an end elevation and a perspective view of another conduit according to the present invention.

### DETAILED DESCRIPTION OF THE DRAWINGS

Aspects and embodiments of the present invention will now be discussed with reference to the accompanying figures. Further aspects and embodiments will be apparent to those skilled in the art. All documents mentioned in this text are incorporated herein by reference.

In the examples that follow, alike features have been given corresponding reference numerals, and corresponding descriptions may apply except where such a description is clearly impermissible or expressly avoided.

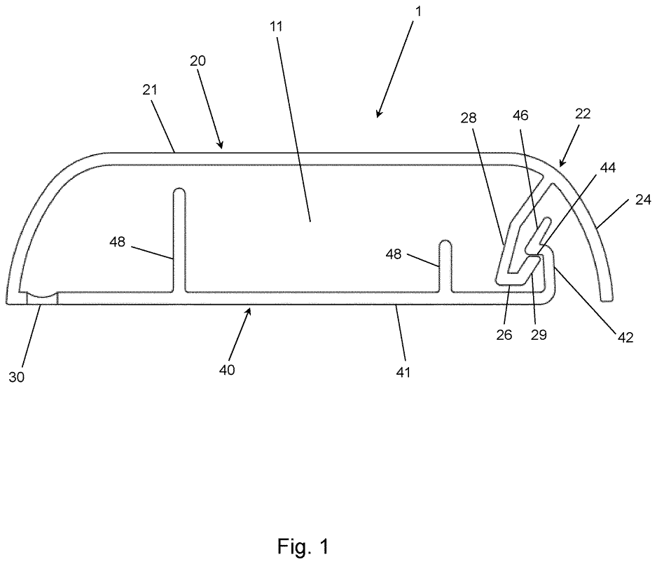

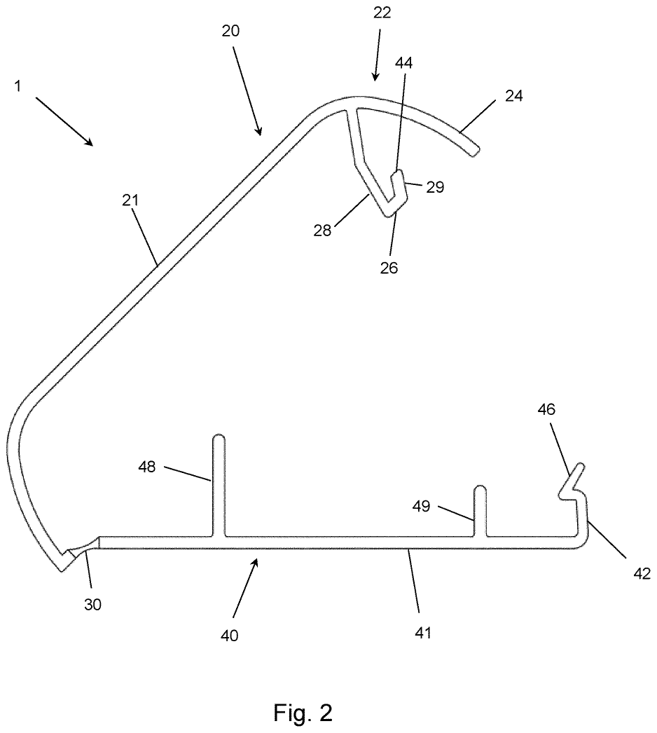

FIG. 1 and FIG. 2 show end elevations of a conduit 1 for housing cables according to the present invention. In FIG. 1 the conduit 1 is open and in FIG. 2 the conduit 1 is closed.

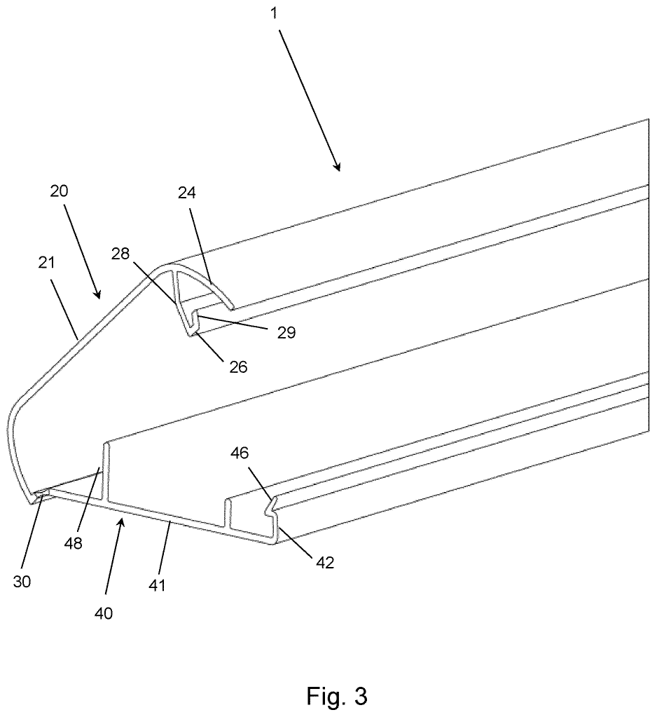

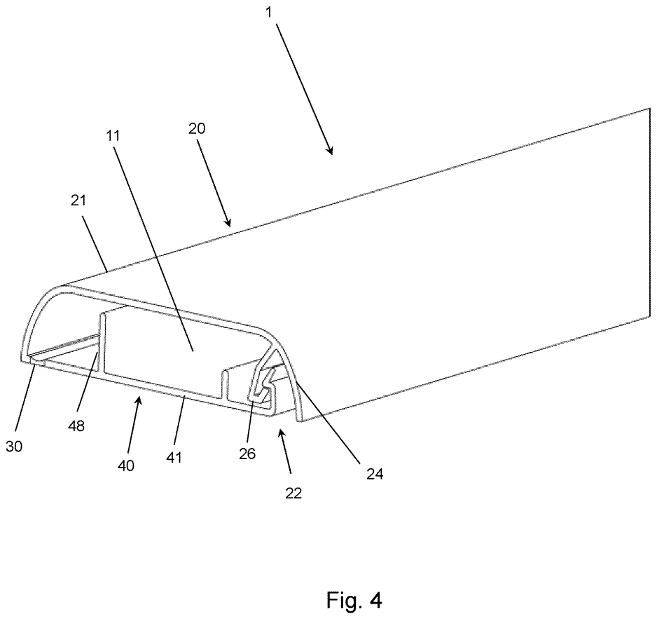

FIGS. 3 and 4 show perspective views of the conduit 1 in open and closed configurations.

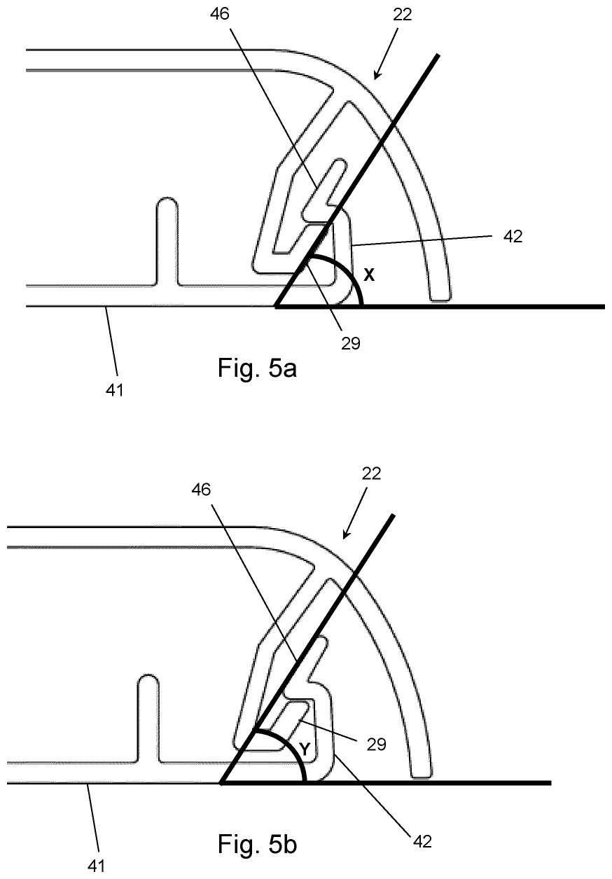

FIGS. 5a and 5b show end elevations of a locking mechanism of the conduit 1 according to the present invention.

The conduit 1 is an elongate member having a longitudinal axis (not shown), a lid portion 20 and a base portion 40.

The base portion 40 comprises a planar base element 41, the planar base element 41 having a flat outer surface for mounting the conduit 1 to a wall or other surface.

The lid portion 20 is attached to the base portion 40 by a longitudinally-extending hinge 30 located on a first side of the longitudinal axis of the conduit 1. The lid portion 20 is rotatable relative to the base portion 40 about the hinge 30 between an open configuration wherein the conduit 1 is open and a closed configuration wherein the conduit 1 is closed. The hinge 30 is located adjacent to and coplanar with the planar element 41 of the base portion 40. Accordingly, the hinge 30 has an axis of rotation which is coplanar with the planar base element 41 of the base portion 40. In this way, cracking and peeling of paint may be reduced if the outer surface of the conduit 1 is painted because the paint will not be deformed at the hinge 30 when the conduit 1 is opened and closed.

The lid portion 20 also comprises a fastening portion 22 on a second side of the longitudinal axis for fastening the lid portion 20 to the base portion 40 when the conduit 1 is closed. The fastening portion 22 of the lid portion 20 comprises an outer wall 24 and an inner projection 26. The base portion 40 comprises a retaining element 42 configured to engage with the inner projection 26. The retaining element 42 of the base portion 40 and the fastening portion 22 of the lid portion 20 therefore form a locking mechanism for fastening the lid portion 20 to the base portion 40.

In FIG. 1, conduit 1 is closed and the lid portion 20 is in the closed configuration. The inner projection 26 is engaged with the retaining element 42 thus locking the lid portion 20 to the base portion 40. This prevents relative rotation between the lid portion 20 and the base portion 40 from the closed configuration to the open configuration. In the closed configuration, the inner surfaces of the base portion 40 and the lid portion 20 thus define a cable-retaining channel 11 for housing cables, wires or other suitable objects.

In FIG. 2, the conduit 1 is open and the lid portion 20 is in the open configuration. The lid portion 20 is angularly displaced about the hinge 30, relative to the base portion 40, thereby defining a gap between the lid portion 20 and the base portion 40 at the second side of the longitudinal axis.

In this example, the inner projection 26 is a resiliently deformable hook projecting from an interior surface of the lid portion 20. The hook comprises a supporting member 28 extending from the interior surface of the lid portion 20 at one end and having an upturned portion projecting partially towards the interior surface of the lid portion 20 at the other end.

The retaining element 42 of the base portion 40 is integrally formed with the planar base element 41 and comprises a ledge 44 having a lower abutment surface. When the lid portion 20 is in the closed configuration the hook fits underneath the ledge 44 in a retaining position and engages with the lower abutment surface. The engagement between the lower abutment surface and the hook locks the lid portion 20 in place relative to the base portion 40 thus preventing relative rotation of the lid portion 20 relative to the base portion 40 from the closed configuration to the open configuration.

The upturned portion of the hook comprises a lower ramp surface 29 having an angle x relative to the planar base element 41 of 20° to 80° when the lid portion 20 is in the closed configuration. In FIG. 5a, the angle x of the lower ramp surface relative to the planar base element is 58°. The ledge 44 of the retaining element 42 has a complementary upper ramp surface 46 having an angle Y relative to the planar base element 41 of 20° to 80°. In FIG. 5b, the angle Y of the upper ramp surface relative to the planar base element is 58°. The upper 46 and lower 29 ramp surfaces are configured to slide against each other when the lid portion 20 is being closed thus guiding the hook into the retaining position below the ledge 44.

When the lid portion 20 is in the closed configuration a user may open the conduit 1 by pushing the outer wall 24 of the fastening portion 22 towards the retaining element 42 thereby applying an inward transverse force to the outer wall 24. The inner projection 26 is configured to disengage from the retaining element 42 by moving away from the retaining element 42 when the user pushes on the outer wall 24. The disengagement of the inner projection 26 from the retaining element 42 disengages the locking mechanism, allowing the lid portion 20 to be opened by moving the lid upwards at the second side thereby rotating the lid portion 20 relative to the base portion 40 from the closed configuration to the open configuration. Advantageously, the conduit is simple and quick to open allowing easy access to cables inside.

The user may also disengage the inner projection 26 from the retaining element 42 by squeezing on both sides of the conduit 1 at the first and second sides of the longitudinal axis thereby applying the inward transverse force to the outer wall 24 of the fastening portion 22 of the lid portion 20 and an opposing inward transverse force to the other side of the lid portion 20. This action causes the lid portion 20 of the conduit 1 to deform upwards, thus moving the inner projection 26 away from the retaining element 42 and disengaging the locking mechanism.

When the lid portion 20 is in the open configuration a user may close the conduit 1 by pushing down on the lid portion 20 thereby rotating the lid portion 20 about the hinge 30 towards the base portion 40 from the open configuration towards the closed configuration. When the lower ramp surface of the hook contacts the upper ramp surface of the retaining element 42, the pushing force from the user causes the lower ramp surface to slide along the upper ramp surface. This sliding motion forces the resiliently deformable inner projection 26 to pivot away from the outer wall 24 of the fastening portion 22 until the upper abutment surface of the hook slips below the ledge 44. The inner projection 26 then pivots back towards the outer wall 24 into a retaining position below the ledge 44 thus locking the lid portion 20 to the base portion 40.

The outer wall 24 of the fastening portion 22 is configured to conceal the remainder of the locking mechanism comprising the retaining element 42 of the base portion 40 and the inner projection 26 of the lid portion 20. In FIG. 1 where the conduit 1 is closed, a lower edge of the outer wall 24 of the fastening portion 22 is coplanar with the planar base element 41 of the base portion 40. Therefore, the inner projection 26 and the retaining element 42 are concealed from view and protected from dust and paint by the outer wall 24.

The hinge 30 is located between an outer edge of the conduit 1 and the longitudinal axis such that the location of the hinge 30 is offset from the outer edge of the conduit. The lid portion 20 forms a corner at the outer edge of the conduit 1 connecting an upper portion of the lid portion 20 to the hinge 30. Therefore, when the base portion 40 of the conduit 1 rests upon a surface and lid portion 20 is rotated relative to the base portion 40 from the closed configuration to the open configuration, the corner of the lid portion 20 performs a pivoting function and the conduit 1 flexes at the hinge 30 as shown in FIG. 2. This pivoting function usefully provides a cable retaining feature by biasing the lid portion 20 towards the closed configuration when the conduit is mounted to a surface.

In this example, the hinge 30 has a flat outer surface which is flush with the outer surface of the planar base element 41 when the lid portion 20 is in the closed configuration thus enabling the conduit 1 to be mounted flush with a wall.

The conduit 1 comprises multiple compartments for receiving different cables. The compartments are separated by interior walls 48 which extend from the planar base element 41 of the base portion 40 towards the lid portion 20 when the lid portion 20 is in the closed configuration. In FIGS. 1 to 4 two interior walls of different heights are shown.

In this example, the lid portion 20 comprises a flat planar lid element 21 which is parallel to the planar base element 41 of the base portion 40 when the lid portion 20 is in the closed configuration. The sides of the lid portion 20, including the outer wall 24 of the fastening portion 22, are curved. However, other shapes of conduit 1 may be possible such as conduits which have outer cross-sections which are semi-circular, quarter circular or rectangular.

The lid portion 20, base portion 40, and hinge 30 of the conduit 1 are made of a thermoplastic such as PVC. The hinge 30 is made from a flexible thermoplastic such as TPE to allow for the relative rotation of the lid portion 20 about the hinge 30.

The lid portion 20 may additionally be covered by a protective film or coating. This film may enable different finishes to be applied to the conduit, e.g. wood effect, metal effect, paint.

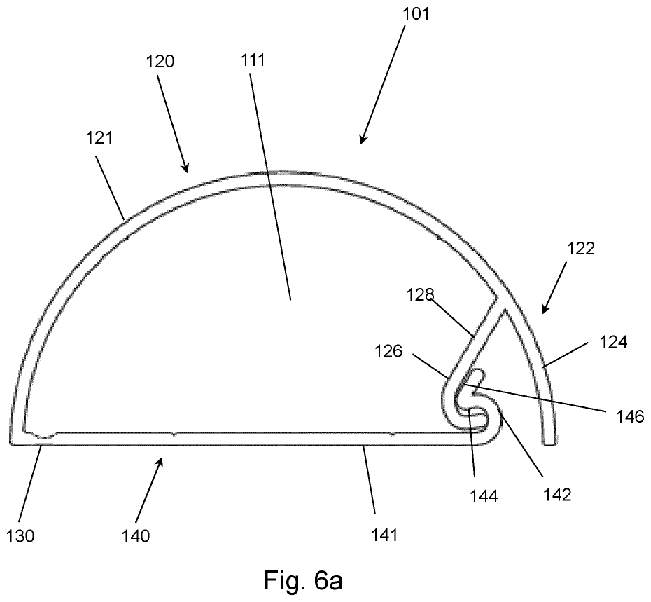

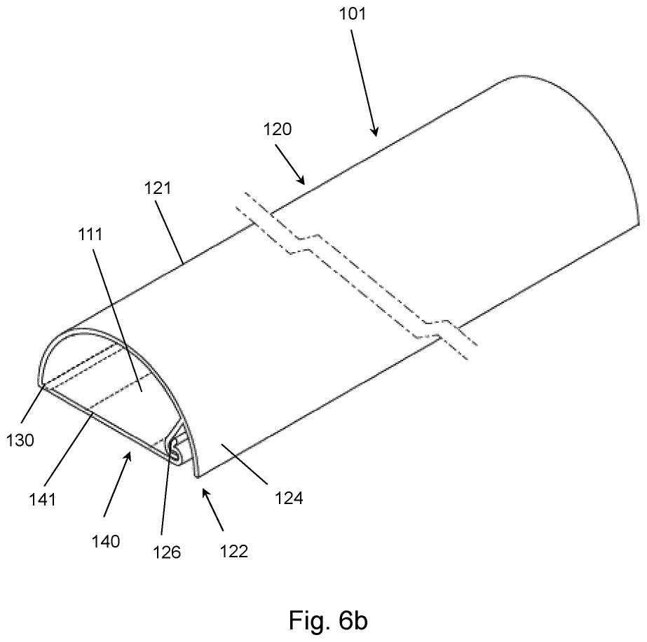

FIGS. 6a and 6b show an end elevation and a perspective view of another conduit 101 for housing cables according to the present invention. As in the previous examples, the conduit 101 is an elongate member having a longitudinal axis (not shown), a lid portion 120 and a base portion 140. In this example, the conduit 101 has a semi-circular cross-section when the conduit 101 is closed.

The base portion 140 comprises a planar base element 141, the planar base element 141 having a flat outer surface for mounting the conduit 101 to a wall or other surface. The lid portion 120 is attached to the base portion 140 by a longitudinally-extending hinge 130 located on a first side of the longitudinal axis of the conduit 101. The lid portion 120 is rotatable relative to the base portion 140 about the hinge 130 between an open configuration wherein the conduit 101 is open and a closed configuration wherein the conduit 101 is closed.

In this example, the lid portion 120 is rounded such that the conduit 101 has semi-circular cross-section. This may be useful for accommodating larger cables in the cable containment channel 111 without increasing the width of the base portion 140.

As described for previous examples, the lid portion 120 comprises a fastening portion 122 for fastening the lid portion 120 to the base portion 140 when the conduit 101 is closed. The fastening portion 122 of the lid portion 120 comprises an outer wall 124 and an inner projection 126. The base portion 140 comprises a retaining element 142 configured to engage with the inner projection 126. The retaining element 142 of the base portion 140 and the fastening portion 122 of the lid portion 120 therefore form a locking mechanism for fastening the lid portion 120 to the base portion 140.

The inner projection 126 is a resiliently deformable hook projecting from an interior surface of the lid portion 120. The hook comprises a supporting member 128 extending from the interior surface of the lid portion 120 at one end and having an upturned portion projecting partially towards the interior surface of the lid portion 120 at the other end.

The retaining element 142 of the base portion 140 is integrally formed with the planar base element 141 and comprises a ledge 144 having a lower abutment surface. When the lid portion 120 is in the closed configuration the resiliently deformable hook fits underneath the ledge 144 in a retaining position and engages with the lower abutment surface.

The locking mechanism 122 of the conduit 101 is configured to operate in the same manner as the locking mechanism 122 of the conduit 1 discussed above in relation to FIGS. 1 to 6. However, in this example, the upturned portion of the resiliently deformable hook comprises a lower ramp surface which is almost parallel with the planar base element 141 when the lid portion 120 is in the closed configuration.

The ledge 144 of the retaining element 142 has an upper ramp surface 146 having an angle Y relative to the planar base element 41 of 20° to 80°. The upper 146 and lower ramp surfaces are configured to slide against each other when the lid portion 120 is being closed thus guiding the hook into the retaining position below the ledge 144.

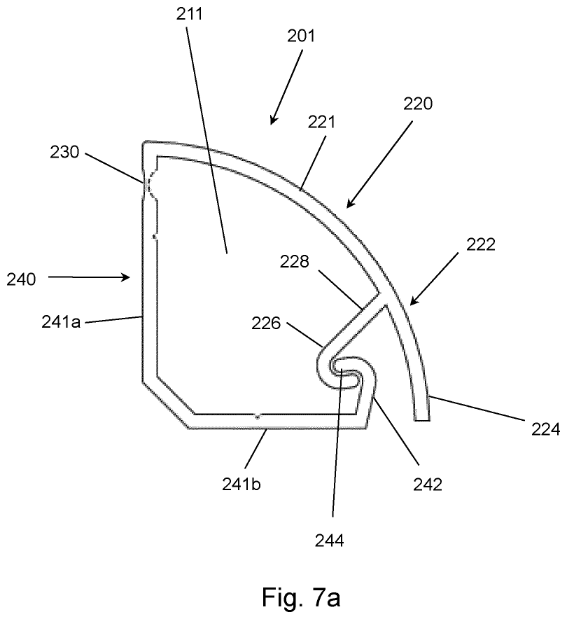

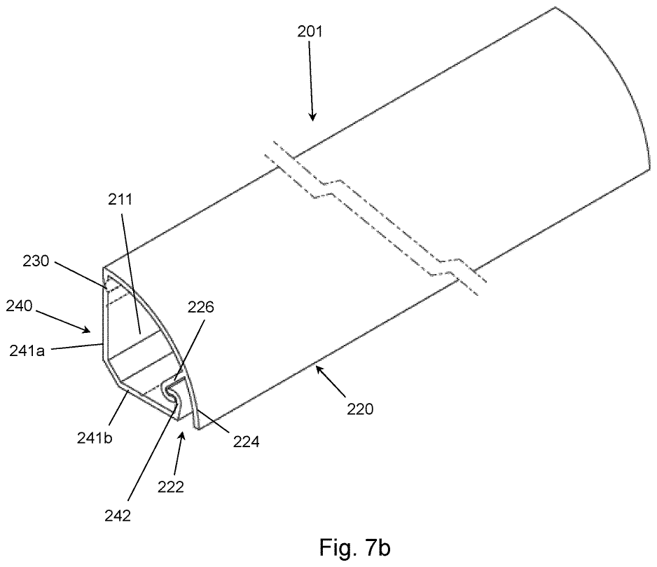

FIGS. 7a and 7b show an end elevation and a perspective view, respectively, of another conduit 201 for housing cables according to the present invention.

In this example, the base portion 220 of the conduit 201 has a first planar base element 241a and a second base element 241b which are perpendicular to each other. Accordingly the conduit 201 is suitable for mounting to a corner, the corner comprising two perpendicular surfaces for receiving the first 241a and second 241b planar base elements. The lid portion 220 of the conduit 201 is rounded such that the conduit 220 has a quarter circular cross-section when the conduit 201 is closed.

As in previous examples, the rounded lid portion 220 is attached to the base portion 240 by a longitudinally-extending hinge 230. The lid portion 220 is rotatable relative to the base portion 240 about the hinge 230 between an open configuration wherein the conduit 201 is open and a closed configuration wherein the conduit 201 is closed.

The planar base portion comprises a retaining element 242 connected to the second planar base element 241. In this example, the first planar base element 241a, the second planar base element 241b, and the retaining element 242 of the base portion 240 are integrally formed.

In this example, the longitudinal axis may be considered as extending from a first end of the conduit 201 to a second end of the conduit 201 and bisecting the first planar base element 241a. As in previous examples, the longitudinally-extending hinge 230 is located on a first side of the longitudinal axis of the conduit 201 and the retaining element 242 is located on a second side of the longitudinal axis.

The lid portion 220 comprises a fastening portion 222 for fastening the lid portion 220 to the retaining element 242 of the base portion 242. The fastening portion 222 of the lid portion 220 comprises an outer wall 224 and an inner projection 126. The retaining element 242 of the base portion 240 and the fastening portion 222 of the lid portion 220 therefore form a locking mechanism for fastening the lid portion 220 to the base portion 240 as described for previous examples. The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A conduit for housing cables, the conduit having a longitudinal axis and comprising:
a lid portion and a base portion, the base portion having a planar base element, wherein
the lid portion is attached to the base portion by a longitudinally-extending hinge located on a first side of the longitudinal axis of the conduit, the lid portion being rotatable relative to the base portion about the hinge between an open configuration and a closed configuration, and the hinge having an axis of rotation which is coplanar with the planar base element of the base portion;
the lid portion comprises a fastening portion on a second side of the longitudinal axis, the fastening portion comprising an outer wall and an inner projection; and
the base portion comprises a retaining element configured to engage with the inner projection;
in the open configuration, the lid portion is angularly displaced about the axis of rotation of the hinge, relative to the base portion, to define a gap between the lid portion and the base portion at the second side of the longitudinal axis of the conduit;
in the closed configuration, the inner projection is engaged with the retaining element such that relative rotation between the lid portion and the base portion from the closed configuration to the open configuration is prevented, and an inner surface of the base portion and an inner surface of the lid portion define a cable-retaining channel; and
in response to an inward transverse force being applied to the outer wall of the fastening portion, the inner projection is configured to disengage from the retaining element thereby allowing relative rotation of the lid portion from the closed configuration to the open configuration.

2. The conduit of claim 1, wherein:
the hinge is a living hinge located adjacent to the planar base element of the base portion.

3. The conduit of claim 1, wherein:
the hinge is located between an outer edge of the conduit and the longitudinal axis.

4. The conduit of a claim 1, wherein:
the hinge is configured to have a flat outer surface when the lid portion is in the closed configuration; and
the flat outer surface of the hinge is configured to be flush with the planar base element of the base portion when the lid portion is in the closed configuration.

5. The conduit of claim 1, wherein:
the lid portion is biased towards the open configuration.

6. The conduit of claim 1, wherein:
the inner projection is resiliently biased towards the outer wall such that when the lid is in the closed configuration the retaining element is resiliently biased towards a retaining position wherein the inner projection is engaged with the retaining element.

7. The conduit of claim 1, wherein:
the retaining element comprises a ledge having a lower abutment surface;
the inner projection comprises a hook configured to fit under the ledge and to engage with the lower abutment surface when the lid portion is in the closed configuration; and
the engagement between the lower abutment surface and the hook prevents relative rotation of the lid portion relative to the base portion from the closed configuration to the open configuration.

8. The conduit of claim 7, wherein:
the hook includes an upper abutment surface configured to engage with the lower abutment surface of the ledge when the lid portion is in the closed configuration, the engagement between the lower abutment surface and the upper abutment surface preventing relative rotation of the lid portion relative to the base portion from the closed configuration to the open configuration.

9. The conduit of claim 7, wherein:
at least one of the inner projection and the retaining element comprises a guiding element configured to guide the hook under the ledge in response to a closing force acting to cause rotation of the lid portion relative to the base portion from the open configuration to the closed configuration.

10. The conduit of claim 9, wherein:
the retaining element comprises a guiding element which is a ramp adjacent to the ledge, ramp having an upper ramp surface at an angle of 20° to 80° relative to the planar base element; and
in response to a closing force applied to the lid portion acting to cause rotation of the lid portion relative to the base portion from the open configuration to the closed configuration, at least a portion of the inner projection is configured to slide along the upper ramp surface thereby guiding the inner projection into a retaining position.

11. The conduit of claim 9, wherein:
the hook of the inner projection comprises a guiding element which is a lower ramp surface, the lower ramp surface at an angle of 20° to 80° relative to the planar base element; and
in response to a closing force applied to the lid portion acting to cause rotation of the lid portion relative to the base portion from the open configuration to the closed configuration, at least a portion of the retaining element is configured to slide along the lower ramp surface, thereby guiding the inner projection into a retaining position.

12. The conduit of claim 11, wherein:
in response to a closing force being applied to the lid portion to cause rotation of the lid portion relative to the base portion from the open configuration to the closed configuration, the lower ramp surface of the inner projection is configured to slide along the upper ramp surface of the retaining element, thereby guiding the inner projection into the retaining position.

13. The conduit of claim 12, wherein:
the angle of the upper ramp surface of the retaining element relative to the planar base element of the base portion and the angle of the lower ramp surface of the hook relative to the planar base element of the base portion are the same.

14. The conduit of claim 1, wherein:
in the closed configuration, a lower edge of the outer wall of the fastening portion is coplanar with the planar base element of the base portion.

15. (canceled)

16. (canceled)

17. The conduit of claim 1, wherein:
the lid portion comprises a planar lid element which is parallel to the planar base element of the base portion when the lid portion is in the closed configuration.

18. (canceled)

19. The conduit of claim 1, wherein:
the planar base element of the base portion is rectangular, the long edges of the rectangle being parallel to the longitudinal axis.

20. The conduit of claim 1, wherein:
the conduit has a uniform cross-section from a first end of the conduit to a second end of the conduit along the longitudinal axis.

21. (canceled)

22. (canceled)

23. (canceled)

24. The conduit of claim 1, wherein:
the retaining element of the base portion is integrally formed with the planar base element.

25. (canceled)

26. A conduit for housing cables, the conduit having a longitudinal axis and comprising:
a lid portion and a base portion having a planar base element, wherein: the lid portion is attached to the base portion by a longitudinally-extending hinge located on a first side of the longitudinal axis of the conduit, the lid portion being rotatable relative to the base portion about the hinge between an open configuration and a closed configuration;
the lid portion comprises a fastening portion on a second side of the longitudinal axis, the fastening portion comprising an outer wall and an inner projection, and the base portion comprises a retaining element configured to engage with the inner projection;
in the open configuration the lid portion is angularly displaced about the hinge, relative to the base portion, to define a gap between the lid portion and the base portion at the second side of the longitudinal axis of the conduit;
in the closed configuration, the inner projection is engaged with the retaining element such that relative rotation between the lid portion and the base portion from the closed configuration to the open configuration is prevented, and inner surfaces of the base portion and the lid portion define a cable-retaining channel; and
in response to an inward transverse force being applied to the outer wall of the fastening portion, the inner projection is configured to disengage from the retaining element thereby allowing relative rotation of the lid portion from the closed configuration to the open configuration.

27. A conduit for housing cables, the conduit having a longitudinal axis and comprising:
a lid portion and a base portion having a planar base element, wherein the lid portion is attached to the base portion by a longitudinally-extending hinge located on a first side of the longitudinal axis of the conduit, the lid portion being rotatable relative to the base portion about the hinge between an open configuration and a closed configuration, and the hinge having an axis of rotation which is coplanar with the planar base element of the base portion;
in the open configuration, the lid portion is angularly displaced about the hinge, relative to the base portion, to define a gap between the lid portion and the base portion at the second side of the longitudinal axis of the conduit;
the conduit further comprises a releasable locking mechanism configured to prevent relative rotation between the lid portion and the base portion, thereby retaining the lid portion in the closed configuration; and
in the closed configuration, inner surfaces of the base portion and the lid portion define a cable-retaining channel.
